(19) United States
(12) Patent Application Publication
(10) Pub. No.: US 2014/0025429 A1
(43) Pub. Date: Jan. 23, 2014

(54) SYSTEMS AND METHODS FOR PROVIDING A SERVICE QUALITY MEASURE

(71) Applicant: Perwaiz Nihal, Dublin, NH (US)

(72) Inventor: Perwaiz Nihal, Dublin, NH (US)

(21) Appl. No.: 14/008,063

(22) PCT Filed: Mar. 28, 2012
(86) PCT No.: PCT/US12/31026

§ 371 Date: Sep. 27, 2013

Related U.S. Application Data
(60) Provisional application No. 61/468,965, filed on Mar. 29, 2011.

(51) Int. Cl. G06Q 30/02; G06Q 50/22

(52) U.S. Cl. CPC G06Q 30/0203; G06Q 50/22
USPC 705/7.32

(57) ABSTRACT

A processor based method of determining a service quality category measure, the method comprising receiving a service event attribute reflecting a service event over a period of time, and automatically correlating the service event attribute with a service quality category to determine a service quality category measure. A processor-based method of providing a service quality category measure, the method comprising receiving a service quality category measure where the service quality category measure represents a correlation of a service event attribute with a service quality category, and providing the service quality category measure to a graphic interface.

### CROSS-REFERENCE TO RELATED APPLICATIONS

This application claims the benefit of U.S. App. No. 61/468,965, filed on Mar. 29, 2011, entitled “SYSTEMS AND METHODS FOR PROVIDING SERVICE QUALITY CONTROL”, the entire contents of which is incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND

In hospitality based industries, customer/client feedback is very important to the service provider, giving the service provider important information regarding how the provided services can be improved. In some situations, customer/client feedback can also contribute to an assessment of the service provider within their respective industry. In still other situations, the customer/client feedback can have an impact on funding provided to the service provider, impacting the level and quality of services that the service provider is able to provide.

### BRIEF SUMMARY

The following summary is included only to introduce some concepts discussed in the Detailed Description below. This summary is not comprehensive and is not intended to delineate the scope of protectable subject matter, which is set forth by the detailed description and the claims presented at the end.

Conventional technologies for enabling service providers to generate self assessment measures suffer from a variety of deficiencies. In particular, conventional technologies for generating self assessment measures are limited in that conventional technologies do not generate self assessment measures that are based on the industry or government standards that are ultimately used to assess the service providers. Conventional technologies do not generate predicted assessment measures that can be used to improve the services while the services are being provided in an effort to positively impact the future results of the industry or government based assessments. Conventional technologies do not provide near real time predicted assessments on an ongoing basis that provide service providers with trending information associated with the services provided.

Embodiments disclosed herein significantly overcome such deficiencies and provide a system that includes a computer system and/or software executing a service quality category measure providing process that receives a service event attribute reflecting a service event over a period of time, and automatically correlates the service event attribute with a service quality category to determine a service quality category measure. In an example embodiment, the service quality category measure providing process provides the service quality category measure to a graphic interface.

In other words, the service quality category measure providing process receives a services event attribute reflecting a service event, such as a service request. The service request may be received from a service recipient receiving services provided by a service provider. In an example embodiment, the service quality category measure providing process automatically correlates the service event attribute with a service quality category to determine a service quality category measure. In an example embodiment, the service quality category measure providing process then provides the service quality category measure to a graphic interface, for example, to report the service quality category measure to a service provider. This may give the service provider important service assessment information in near real time, allowing the service provider the opportunity to improve the services that are provided to service recipients. By providing assessment information on an ongoing basis, the service provider can determine how the assessment is trending, for example, with respect to time.

In an example embodiment, the service quality category measure providing process receives a service event attribute reflecting a service event over a period of time. The service quality category measure providing process automatically correlates the service event attribute with a service quality category to determine a service quality category measure. In an example embodiment, the service request attribute may comprise a service request, and the service quality category may comprise a plurality of service quality categories. The plurality of service quality categories may comprise at least one selected from the group consisting of a comfort category, a communication category, and a care category.

In an example embodiment, the service event attribute comprises a service request attribute. The service quality category comprises a plurality of service quality categories where the plurality of service quality categories comprises at least one selected from the group consisting of a cleanliness category, a quietness category, a communication sub-category (i.e., communication with doctors, communication with nurses, and/or communication about medicines), and a pain management category. The plurality of service quality categories may further comprise a responsiveness category and/or a discharge information category.

In an example embodiment, the service event attribute may be a service request initiated by a patient in a health care facility, and the service quality category may comprise at least one service quality category that correlates to an HCAHPS measure.

In an example embodiment, the service event attribute may comprise a service assessment. The service quality category may comprise a plurality of service quality categories where the plurality of service quality categories comprise at least one selected from a comfort category, a communication category, and a care category. The service quality category may comprise a plurality of service quality categories, where the plurality of service quality categories comprises at least one selected from the group consisting of a responsiveness category, and a discharge information category. The plurality of service quality categories may further comprise at least one selected from the group consisting of a cleanliness category, a quietness category, a communication sub-category, and a pain management category.

In an example embodiment, the service request attribute may comprise a service assessment of a health care provider, and the service quality category may comprise at least one service quality category correlating to an HCAHPS measure.

In an example embodiment, the service quality category measure providing process may correlate the service quality category measure to a predicted service quality category measure.

In an example embodiment, the service quality category measure providing process receives a third party service quality category measure. The service quality category measure providing process compares the third party service quality category measure to the service quality category measure to create an actual category measure difference. The service quality category measure providing process then compares the third party service quality category measure to the predicted service quality category measure to create an actual predicted measure category difference. In an example embodiment, the step of correlating the service quality measure utilizes a predicting model. The service quality category measure providing process may update the predicting model based on the actual category measure difference and the predicted measure category difference.

In an example embodiment, the service event comprises a plurality of service events in a health care facility, and the service quality category comprises a plurality of service quality categories correlating to HCAHPS measures. The third party service quality category measure comprises a HCAHPS result.

In an example embodiment, the service event attribute comprises a service request attribute of a service request initiated by a patient in a hospital, and the service quality category measure is communicated to a graphic interface in near real time.

In an example embodiment, the service quality category measure providing process receives a new service event with at least one new service event attribute, within the period of time. The service quality category measure providing process determines an updated service quality category measure based on the new service event attribute and the service event attribute. The service quality category measure providing process also determines a trending measure associated with the updated service quality category measure reflecting a trend between the service quality category measure and the updated service quality category measure.

In an example embodiment, the service quality category comprises a plurality of service quality categories. The step of correlating the service event attribute with a service quality category to determine a service quality category measure comprises correlating the service event attribute with at least one of the plurality of service quality categories, and then tabulating the service quality category measure as a sum of the service event attributes correlated to at least one of the plurality of categories over the period of time.

In an example embodiment, a service process defect is associated with the service event attribute and a suggested improvement event is communicated to a service provider based on the service process defect.

In an example embodiment, the service quality category measure providing process receives a service quality category measure where the service quality category measure represents a correlation of a service event attribute with a service quality category. The service quality category measure providing process provides the service quality category measure to a graphic interface. In some embodiments, the service quality category measure providing process receives an updated service quality category measure, and provides the updated service quality category measure to the graphic interface at a near real time.

In an example embodiment, the service event attribute comprises a service request attribute of a service request initiated by a patient in a health care facility, and the service quality category comprises at least one service quality category correlating to at least one HCAHPS measure.

In an example embodiment, the service event attribute comprises a service assessment attribute of a service assessment initiated by a health care provider. The service quality category comprises at least one service quality category correlating to at least one HCAHPS measure.

In an example embodiment, the service quality category measure is a predicted service quality category measure of at least one HCAHPS measure.

In an example embodiment, the service quality category measure providing process provides a suggested improvement event based on the service event attribute and the service quality measure.

In an example embodiment, the service quality category measure providing process provides the service quality category measure to a graphic interface by receiving a user selection of a service quality category measure representation associated with the service quality category measure. The service quality category measure comprises a plurality of service quality category attributes. The service quality category measure providing process provides the plurality of service quality category attributes on the graphic interface.

In an example embodiment, the service quality category measure providing process provides a plurality of service quality category sub-attributes upon a user selection of one of the plurality of selectable service quality category attributes.

In an example embodiment, the service quality category measure providing process modifies an appearance of a service quality category measure representation based on at least one service quality measure threshold associated with the service quality category measure.

In an example embodiment, the service quality category measure providing process presents at least one menu screen on a graphic interface, where the menu screen has at least one selectable service request attribute corresponding to a service request. The service quality category measure providing process recognizes a selection of the selectable service request attribute as a user selection, and communicates the user selection to a service quality category measure system whereby a service quality category measure can be determined. In some embodiments, the selectable service request attribute may be a free text entry field.

In an example embodiment, the service request attribute is related to a service quality category measure, and the service quality category measure is associated with an HCAHPS measure.

In an example embodiment, at least one selectable service request attribute is related to a service quality category. The service quality category comprises at least one selected from the group consisting of a comfort category, a communication category, and a care category.

In an example embodiment, the service request attribute comprises a service request related to a service quality category. The service quality category comprises at least one selected from the group consisting of a cleanliness category, a quietness category, a communication sub-category (such as communication with doctors, communication with nurses and/or communication about medicines), a pain management category, a responsiveness category, and a discharge information category.

Embodiments disclosed herein relate to quality control systems and measures, such as a service quality category measure system executing a service quality category measure providing process, in particular systems and methods that are based on information provided by a service recipient receiving services from a service provider.

Embodiments disclosed herein also relate to the field of Customer Service, which for example and not for limitation can include health care, hospitality, retail, call centers, restaurants and food service etc. More particularly, embodiments disclosed herein may provide a mechanism and methodology for gauging quality of service and doing quality control by using service requests and assessments as a ‘service process defect’. Some embodiments can track, aggregate and provide timely and continuous feedback to service providers that can help them react and improve base processes used in their service.

### BRIEF DESCRIPTION OF THE SEVERAL VIEWS OF THE DRAWINGS

In order that the manner in which the above-recited and other advantages and features of embodiments disclosed herein are obtained, a more particular description of embodiments disclosed herein briefly described above will be rendered by reference to specific embodiments thereof which are illustrated in the appended drawings. Understanding that these drawings depict only typical embodiments and are not therefore to be considered to be limiting of its scope, embodiments disclosed herein will be described and explained with additional specificity and detail through the use of the accompanying drawings in which:

FIG. 1 illustrates a high level overview of one embodiment of the systems and methods disclosed herein.

FIG. 2 illustrates a general process diagram of one embodiment of the methods disclosed herein.

FIG. 3A illustrates a process diagram including entities of one embodiment of the methods of embodiments disclosed herein.

FIG. 3B illustrates a general overview process diagram of one embodiment of the methods disclosed herein.

FIG. 4A illustrates a flowchart of a procedure performed by the system of FIG. 1, when the service quality category measure providing process receives a service event attribute reflecting a service event over a period of time, according to one example embodiment disclosed herein.

FIG. 4B illustrates a flowchart of a procedure performed by the system of FIG. 1, when the service quality category measure providing process correlates the service quality category measure to a predicted service quality category measure, according to one example embodiment disclosed herein.

FIG. 5A illustrates a flowchart of a procedure performed by the system of FIG. 1, when the service quality category measure providing process automatically correlates the service event attribute with a service quality category to determine a service quality category measure, according to one example embodiment disclosed herein.

FIG. 5B illustrates a flowchart of a procedure performed by the system of FIG. 1, when the service quality category measure providing process automatically correlates the service event attribute with at least one of a plurality of service quality categories to determine a service quality category measure, according to one example embodiment disclosed herein.

FIG. 6A illustrates a flowchart of a procedure performed by the system of FIG. 1, when the service quality category measure providing process receives a service quality category measure, according to one example embodiment disclosed herein.

FIG. 6B illustrates a flowchart of a procedure performed by the system of FIG. 1, when the service quality category measure providing process provides the service quality category measure to a graphic interface, according to one example embodiment disclosed herein.

FIG. 7 illustrates a flowchart of a procedure performed by the system of FIG. 1, when the service quality category measure providing process presents at least one menu screen on a graphic interface, according to one example embodiment disclosed herein.

FIG. 8 illustrates an overview of the elements of one embodiment of a service quality measure system.

FIG. 9 illustrates one embodiment of a processor based embodiment of a service quality measure system.

FIG. 10 illustrates one embodiment of a computer program product according to one embodiment of the service quality measure system.

FIG. 11 illustrates an example screen shot of one embodiment of a patient perspective indicator.

FIG. 12 illustrates an example screen shot of one embodiment of a plurality of service quality category sub-attributes provided by the service quality category measure system.

### DETAILED DESCRIPTION OF THE INVENTION

Systems and methods to provide service quality control and service quality measure, such as a service quality category measure system executing a service quality category measure providing process, will now be described in detail with reference to the accompanying drawings. It will be appreciated that, while the following description focuses on a system that provides service quality measure for a medical service provider embodiment, the systems and methods disclosed herein have wide applicability. For example, the service quality category measure system and methods described herein may be readily employed with retail, restaurant, computer support, data communication support or any other service provider environment where the service recipient has a dialog or other communication with the service providers. Notwithstanding the specific example embodiments set forth below, all such variations and modifications that would be envisioned by one of ordinary skill in the art are intended to fall within the scope of this disclosure.

Embodiments disclosed herein provide a system that includes a computer system and/or software executing a service quality category measure providing process that receives a service event attribute reflecting a service event over a period of time, and automatically correlates the service event attribute with a service quality category to determine a service quality category measure. In an example embodiment, the service quality category measure providing process provides the service quality category measure to a user interface such as a graphic interface.

In an example embodiment, the service event is a service request initiated by a patient in a health care facility, and the service quality category correlates to at least one industry standard measure, such as but not limited to a Hospital Consumer Assessment of Healthcare Providers and Systems (HCAHPS) measure.

One Example Embodiment of Methods of Providing a Service Quality Category Measure:

In one embodiment of the service quality category measure methods, the methods comprise receiving at least one service event attribute from the service recipient, and automatically determining a quality measure, such as a service quality category measure, of the service provider from the service request. Using a hospital setting as an example for illustration and not for limitation, the service recipients would be patients that have the ability to make service requests directly or indirectly through any device that provides a user interface such as, but not limited, to a personal computer, a tablet computer, a personal digital assistant, a handheld communications device, a voice activated device, or a telephone which is used to receive service requests and communicate them or otherwise share them with the service provider and the service provider system. The service provider in this example is the hospital and hospital staff providing the service. The service provider is able to receive the service requests for response and is able to store, consolidate, analyze and manipulate data representing the request and response.

In another example embodiment, the service quality category measure system may be used in any hospitality industry. In this example embodiment, the service quality category measure may be an industry standard associated with the services provided by the hospitality service provider. The service quality category measure may also be based on a government standard.

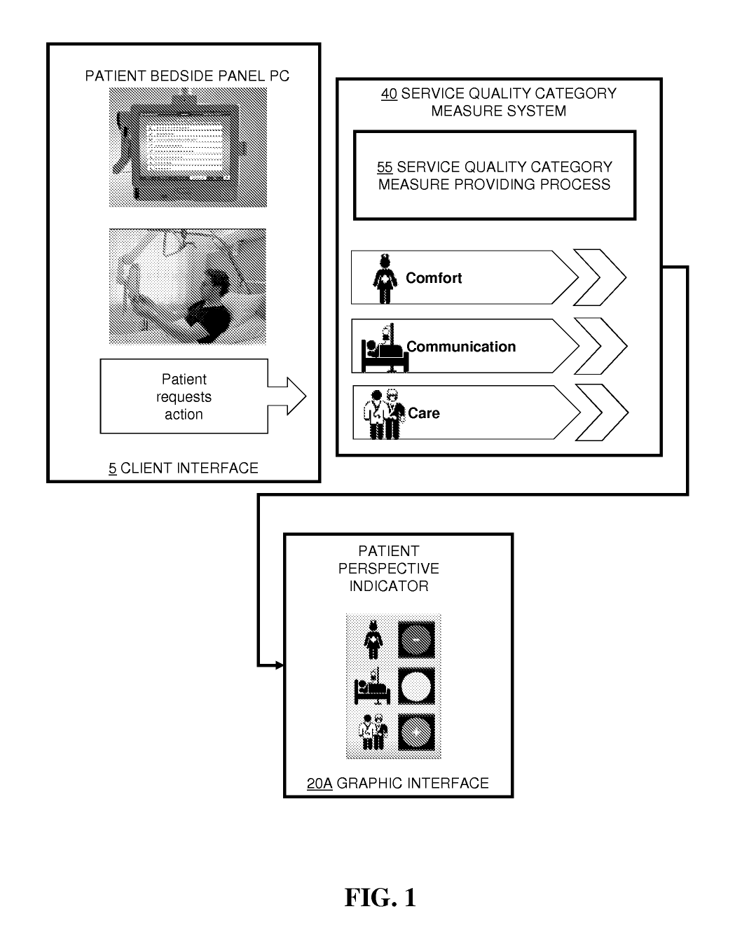

One embodiment of service quality category measure system 40 is shown in FIG. 1. The service quality category measure system 40 executes the service quality category measure providing process 55. A service recipient, for example, a patient in a hospital, makes a service request for action, for example, using Patient Bedside Panel PC operating as a user interface, here illustrated as a client interface 5. The client interface 5 may be any type of user interface or graphic interface that accepts input from a user. An input device (e.g., one or more user/developer controlled devices such as a keyboard, mouse, touch pad, voice activated device, etc.), such as a graphic interface, allows a user to provide input commands to the client interface 5.

The service request impacts feedback of the service quality category measure system 40. For example, service requests are aggregated, and an increase in service requests reduces a service quality category measure. By tracking and updating the service requests received, statistics related to the requests, such as a running average of requests, can be computed. These statistics can be plotted over a time period to indicate improvement, worsening or no change in the statistics. Service requests and statistics selected to reflect quality control can be used to provide service quality category measures. In an example embodiment, the service requests are non-emergency service requests. Providing users with a Patient Bedside Panel PC offloads non-emergency patient requests from the hospital call button to the service quality category measure system 40.

As shown, but not necessary in all embodiments, some embodiments categorize requests into categories such as, but not limited to, Care, Communication and Comfort. Requests made in categories can be used to define measures for feedback, service quality, service quality control, and service quality measure. By calculating and tracking other statistics, such as historical rates of requests and running averages of requests, other measures, such as trends of service quality can be determined. As shown in this embodiment, as the Patient Perspective Indicator, but not necessary in all embodiments, the measures can also be outputted to a reporting or display system such as desktop widget or a measure/icon on an executive dashboard rendered on any type of user interface, such as a graphic interface 20A.

Not shown in FIG. 1, but contemplated and described later, if the requests and measures are carefully defined, they can be used to predict similar measures that may be calculated by other systems and other parties.

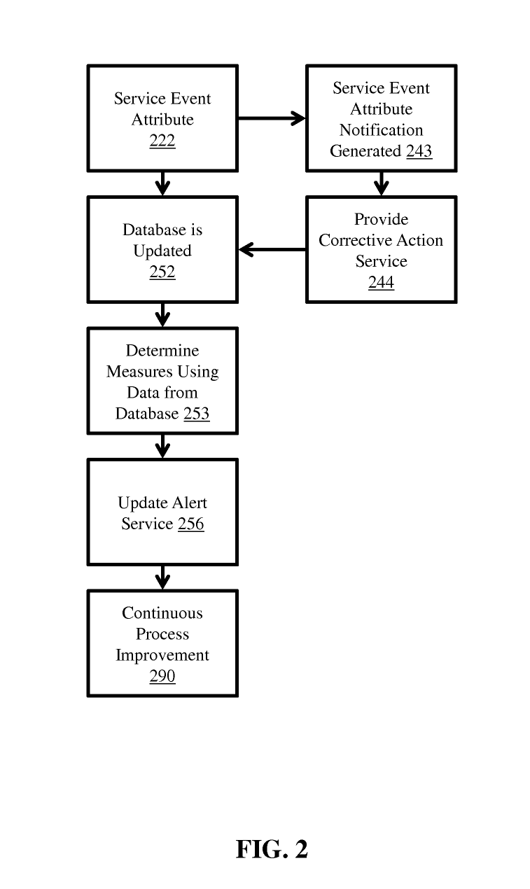

FIG. 2 illustrates a process followed by one embodiment of the methods of providing service quality measure. As shown, the process steps include generating a service event attribute 222 and providing that service event attribute to a step where a service database is updated 252 and providing the service event attribute to a step where a service event attribute notification is generated 243. In one embodiment, the database and notification generation is done within the service quality category measure system. The notification is provided to the service provider where they provide a corrective action service 244. When the service is conducted, the database is also updated 252. From the database entries, measures are determined at 253. An alert service, such as an executive dashboard can be updated at 256 and the information from the methods can be used as input to a continuous process improvement step 290.

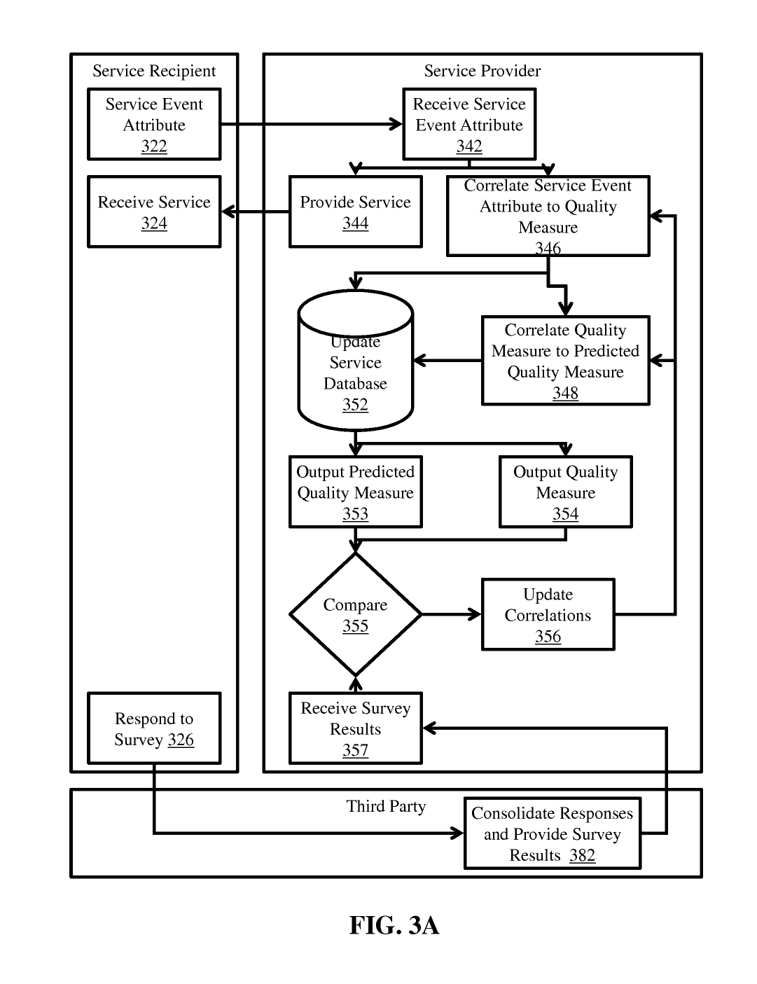

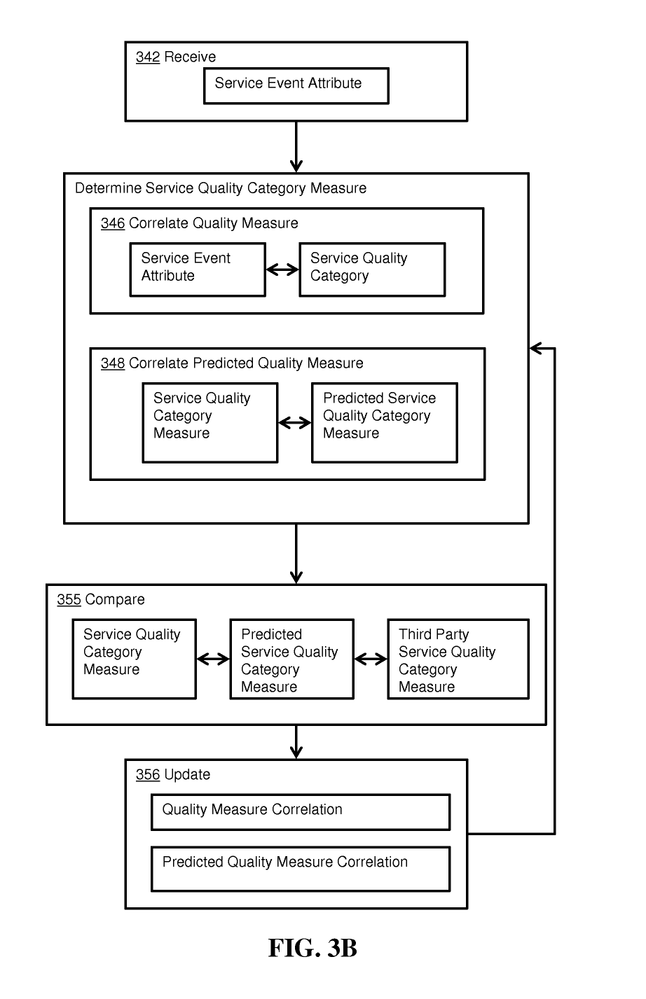

FIG. 3A illustrates another embodiment of methods of the service quality category measure providing process. As shown, the methods include steps generally broken out by three different entities that are likely to be involved with that step. As shown, the service recipient performs a few steps and receives actions in other steps. The service provider, directly, indirectly or through the service quality category measure system performs a few steps. And as shown, in some embodiments, a third party can be involved and perform some steps in the process.

Referring to the steps of FIG. 3A, the process starts with the service recipient generating a service event attribute 322. This service event attribute is received by the service provider at 342. These service event attributes may be in the form of any type of service request of the service provider. These service event attributes may also be service assessment attributes. The service event attribute may be either selected from a list of pre-populated items or questions, or may be free-form text entry as well. In one embodiment, three broad areas or dimensions for requests (and assessment) are defined as Comfort, Communication and Care. Within these categories, the requests can comprise, but are not limited to: cleanliness requests, quietness requests, communication requests (such as communication with doctors, communication with nurses, and/or communication about medicines), responsiveness requests, pain management requests, and discharge information requests. Examples of typical requests include: “I need to ask my doctor some follow-up questions”, “I need more pain medication”, “I have questions about what I need to do after I go home”, “I need my room cleaned again”, “I need to speak with my nurse”, “My call button doesn't seem to be working”, “I have questions about my medication and dosage”, and “My room is very noisy”. Assessments and assessment attributes may also have similar categories.

With this service event attribute, the service provider then may provide the service at 344 (and the service recipient may receive the service at 324) as well as uses this service event attribute to correlate to a quality measure at 346. The service event attribute and quality measure may also be correlated to a predicted quality measure at 348.

As discussed herein, a quality measure, such as a service quality category measure, is any measure of the service provided by the service provider. Example measures include, but are not limited to service process defects, service recipient satisfaction, timeliness of response, number of service requests, and number of service requests over time. In one embodiment, the measure can comprise measures such as Comfort Measures such as Cleanliness of the Hospital and Quietness of the hospital; Communication Measures such as Communication with doctors, Communication with nurses and Communication about medicines; and Care Measures such as Responsiveness of hospital staff, Discharge Information and Pain Management. In one preferred embodiment, one quality measure comprises a running average of an individual type or of categories of measures, and another quality measure can be the trending of the running average to show whether it is improving, worsening or not changing.

As discussed herein, a predicted quality measure is a measure that may also be used to predict another measure. For example, and not for limitation, in a hospital environment, the quality measure can measure service attributes that very closely parallel the measures of a HCAHPS (Hospital Consumer Assessment of Healthcare Providers and Systems) survey and the predicted quality measure can be an expected score in a HCAHPS category. In one embodiment, the HCAHPS includes Six Composite Measures [Communication with Nurses (comprised of three HCAHPS survey items); Communication with Doctors (comprised of three HCAHPS survey items); Responsiveness of Hospital Staff (comprised of two HCAHPS survey items); Pain Management (comprised of two HCAHPS survey items); Communication About Medicines (comprised of two HCAHPS survey items); Discharge Information (comprised of two HCAHPS survey items)]; Two Individual Items (Cleanliness of Hospital Environment and Quietness of Hospital Environment); and Two Global Items (Recommend the Hospital and Overall Hospital Rating). Additionally, the HCAHPS Expanded Survey may include an additional Composite Measure, “About You” (comprised of five HCAHPS survey items). In an example embodiment, HCAHPS survey items may be or include HCAHPS survey questions. An example embodiment of an HCAHPS survey is described below.

HCAHPS categories include the HCAHPS measures from the survey instrument as defined in the CAHPS Hospital Survey (HCAHPS) Quality Assurance Guidelines, Version 6.0, March 2011, and Version 7.0, March 2012, as published by Center for Medicare & Medicaid Services which are herein incorporated by reference in their entirety. As should be evident when comparing the quality measures described above, they purposely align with the categories and measures of the HCAHPS allowing some quality measures to serve as predicted quality measures. As described for the quality measures, statistics can be kept for averages of predicted quality measure and trends related to that measure can be determined and provided as system feedback.

The correlation of the service event attribute to a measure may be helpful in some embodiments where the service recipient's user interface allows some free form requests or the request as presented do not directly align with a measure. For these embodiments, the service event attribute may be pre-categorized to correlate or otherwise be related to a measure, and these service event attributes may be presented as service requests in a pull-down type menu to the service recipient. For free form embodiments of making service event attributes, text elements or context of the service event attribute may be used to correlate a service event attribute to a measure.

Referring back to FIG. 3A, the quality measure and the predicted quality measure are stored in the service database 352. It is understood that although the illustration describes correlating measure prior to updating the database, the service event attribute data can also be stored in the database first, and then used to determine/correlate the quality and predicted quality measures.

Having determined the quality measure and the predicted quality measure, these measures are outputted at steps 353 and 354. The process of outputting quality measure at 354 may include determining a trend measure that reflects a trend between a service quality category measure, and an updated service quality category measure. The process of outputting quality measure at 354 may also include determining a threshold, associated with the service quality category measure that is reflected in the service quality category measure representation when the service quality category measure representation is rendered on a graphic interface.

Generally, this process results in an output of feedback from the service, based on service recipients, suggesting areas for improvement and providing an ongoing metric to assess progress. The output may be provided live, and may be provided to an output device such as a computer interface. The interface can provide a detailed representation of the data, or provide a summary like an executive dashboard icon or widget having color codes such as red, green and yellow when bad, good or warning levels of measures are detected. The output may also provide additional manipulations of data in the database to include running averages of the data, trending of the data and other statistical metrics to help understand the data.

In some embodiments, the methods further comprise aggregating the service event attributes for analysis and culling actionable data from the service event attributes.

In some embodiments, the methods also include incorporating steps or data from a third party. As shown, a third party may also provide a survey for the service recipient to complete at step 326. The third party can consolidate the responses of the survey, and provide them in step 382 to the service provider. The service provider can receive the results at step 357, and use them to compare to the measures from the system at 355. As part of the methods and continuous process improvement, the comparison results can be used to update the methods of correlating the service event attributes to the measures at 356.

One result of this embodiment is that based on the number of service event attributes received, the methods can accurately predict the nature of HCAHPS scores the hospital would receive. These methods provide an ability to aggregate real-time data into actionable items, and provide a means of improving HCAHPS scores well before the HCAHPS scores will be determined.

FIG. 3B illustrates a process diagram of one embodiment of a general overview of the method of determining a service quality category measure. The service quality category measure providing process receives a service event attribute at 342. The service event attribute reflects a service event over a period of time. To determine a service quality category measure, at 346, the service quality category measure providing process automatically correlates the service event attribute with a service quality category. At 348, the service quality category measure providing process also correlates the service quality category measure to a predicted service quality category measure.

At 355, the service quality category measure providing process receives a third party service quality category measure. The service quality category measure providing process then compares the third party service quality category measure to the service quality category measure to create an actual category measure difference. The service quality category measure providing process also compares the third party service quality category measure to the predicted service quality category measure to create an actual predicted measure category difference. This step of correlating the service quality measure utilizes a predicting model. At 356, the service quality category measure providing process updates the quality measure correlation and the predicted quality measure correlation by updating the predicting model based on the actual category measure difference and the predicted measure category difference.

The process of correlating may be any type of direct or probabilistic comparison of data representing the measures. For illustration only, and not for limitation, suitable models for correlation include deterministic or probabilistic models or static or dynamic models. In one embodiment, the correlation is performed by a pre-determined set of measures and service event attributes that are mapped to other measures and service event attributes through fields of a database.

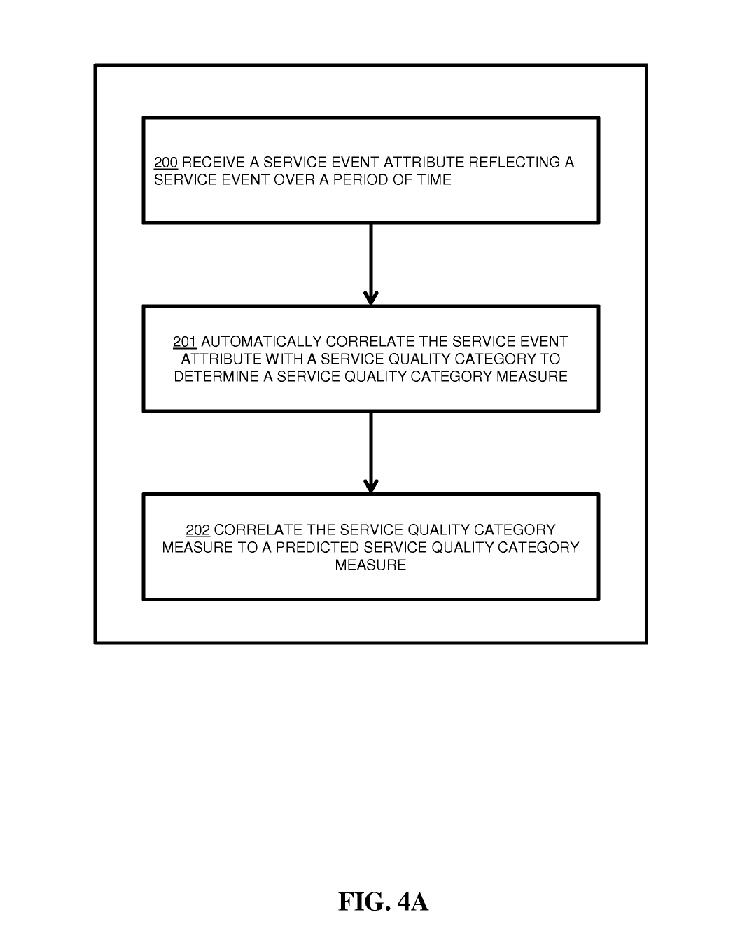

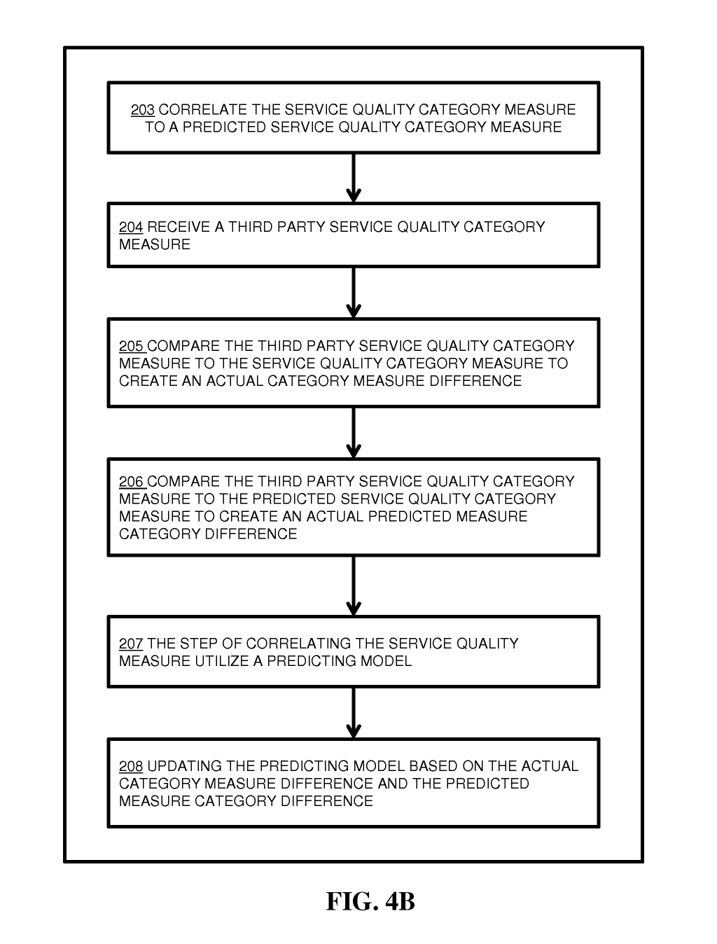

FIG. 4A is an embodiment of the steps performed by the service quality category measure providing process when it receives a service event attribute reflecting a service event over a period of time.

In step 200, the service quality category measure providing process receives a service event attribute reflecting a service event over a period of time. In an example embodiment, the service event may be a result of a service request entered by a service recipient, for example, to notify a service provider of a service process defect. The service quality category measure providing process receives the service request in the form of a service event. The service event may be comprised of a plurality of service event attributes. For example, the service event attributes may include information associated with the service request, the service recipient who entered the service request, the service provider tasked with resolving the service request, the time of the service request, information associated with a running average of similar service events over a time period, a deadline by which the service request must be addressed, resolution of the service request, etc. In step 201, the service quality category measure providing process automatically correlates the service event attribute with a service quality category to determine a service quality category measure.

In an example embodiment, the service event attribute comprises a service request attribute. The service quality category comprises a plurality of service quality categories where the plurality of service quality categories comprises at least one selected from the group consisting of a comfort category, a communication category, and a care category.

In an example embodiment, the service event attribute comprises a service request attribute. The service quality category comprises a plurality of service quality categories where the plurality of service quality categories comprises at least one selected from the group consisting of a cleanliness category, a quietness category, a communication sub-category, and a pain management category. The communication sub-category may include communication with doctors, communication with nurses, and/or communication about medicines. In an example embodiment, the plurality of service quality categories further comprises at least one selected from the group consisting of a responsiveness category, and a discharge information category.

In an example embodiment, the service event attribute comprises a service request attribute initiated by a patient in a health care facility. The service quality category comprises at least one service quality category correlating to an HCAHPS measure.

In an example embodiment, the service event attribute comprises a service assessment attribute. The service quality category comprises a plurality of service quality categories where the plurality of service quality categories comprises at least one selected from the group consisting of a comfort category, a communication category, and a care category.

In an example embodiment, the service event attribute comprises a service assessment attribute. The service quality category comprises a plurality of service quality categories where the plurality of service quality categories comprises at least one selected from the group consisting of a responsiveness category, and a discharge information category. In an example embodiment, the plurality of service quality categories further comprises at least one selected from the group consisting of a cleanliness category, a quietness category, a communication sub-category (such as communication with doctors, communication with nurses and/or communication about medicines), and a pain management category.

In an example embodiment, the service event attribute comprises a service assessment attribute of a service assessment of a health care provider. The service quality category comprises at least one service quality category correlating to an HCAHPS measure.

In step 202, the service quality category measure providing process correlates the service quality category measure to a predicted service quality category measure. The predicted service quality category measure is a prediction of the service quality category measure with respect to the received service event attribute. In an example embodiment, when the service quality category measure providing process correlates the service event attribute with a service quality category to determine a service quality category measure, the service quality category measure providing process then also correlates the service quality category measure to a predicted service quality category measure to refine the service quality category measure.

In an example embodiment, a service process defect is associated with the service event attribute. In an example embodiment, the service request may be associated with a “service process defect”. When the service quality category measure providing process receives the service event, this “service process defect” may be one of the service event attributes associated with the service event. The service quality category measure providing process may communicate a suggested improvement event to a service provider based on the service process defect associated with the service event. The suggested improvement event is a suggestion to address the service process defect.

FIG. 4B is an embodiment of the steps performed by the service quality category measure providing process when it correlates the service quality category measure to a predicted service quality category measure.

In step 203, as described above in step 202, the service quality category measure providing process correlates the service quality category measure to a predicted service quality category measure. In step 204, the service quality category measure providing process receives a third party service quality category measure. In an example embodiment, the third party service quality category measure may be provided, for example, by a previous service recipient who is now providing feedback based on the quality of service that the service recipient received from the service provider. In another example embodiment, the third party service quality category measure may be provided by a third party who may provide industry evaluations associated with service providers. In step 205, the service quality category measure providing process compares the third party service quality category measure to the service quality category measure to create an actual category measure difference. In step 206, the service quality category measure providing process compares the third party service quality category measure to the predicted service quality category measure to create an actual predicted measure category difference. In step 207, the service quality category measure providing process utilizes a predicting model during the step of correlating the service quality measure. In an example embodiment, the predicting model provides information enabling the service quality category measure providing process to correlate the service quality category measure to the predicted service quality category measure to refine the service quality category measure to more likely to reflect an actual service quality category measure that will eventually be provided by, for example, a third party. In step 208, the service quality category measure providing process updates the predicting model based on the actual category measure difference and the predicted measure category difference.

The predicting model may be any type of predictive model, such as a statistical model, to predict or extrapolate a measure based on past measures. For illustration only, and not for limitation, suitable statistical models include linear regression analysis or moving averages of selected measures.

In an example embodiment, the service event comprises a plurality of service events in a health care facility. The service quality category comprises a plurality of service quality categories correlating to HCAHPS measures, and the third party service quality category measure comprises a HCAHPS result. For example, a patient who was recently hospitalized may fill out an HCAHPS survey related to their recent hospital stay. Those HCAHPS results are reported back to the hospital. The third party service quality category measure may comprise the HCAHPS results reported back to the hospital. An example embodiment of an HCAHPS survey is described below.

In an example embodiment, the service event attribute comprises a service request attribute of a service request initiated by a patient in a hospital. The service quality category measure is communicated to a graphic interface in near real time.

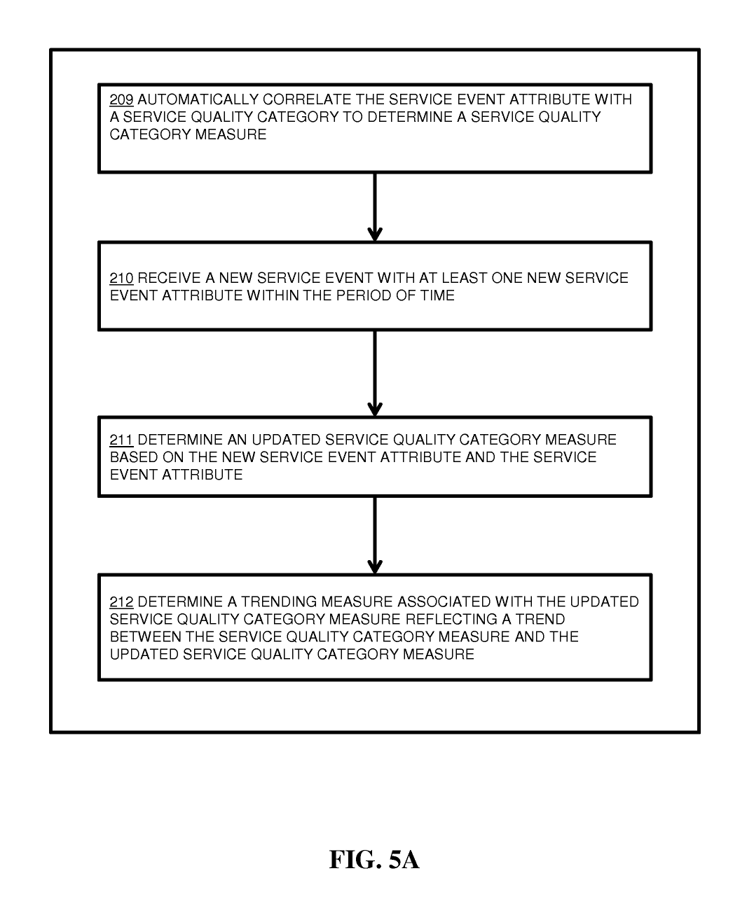

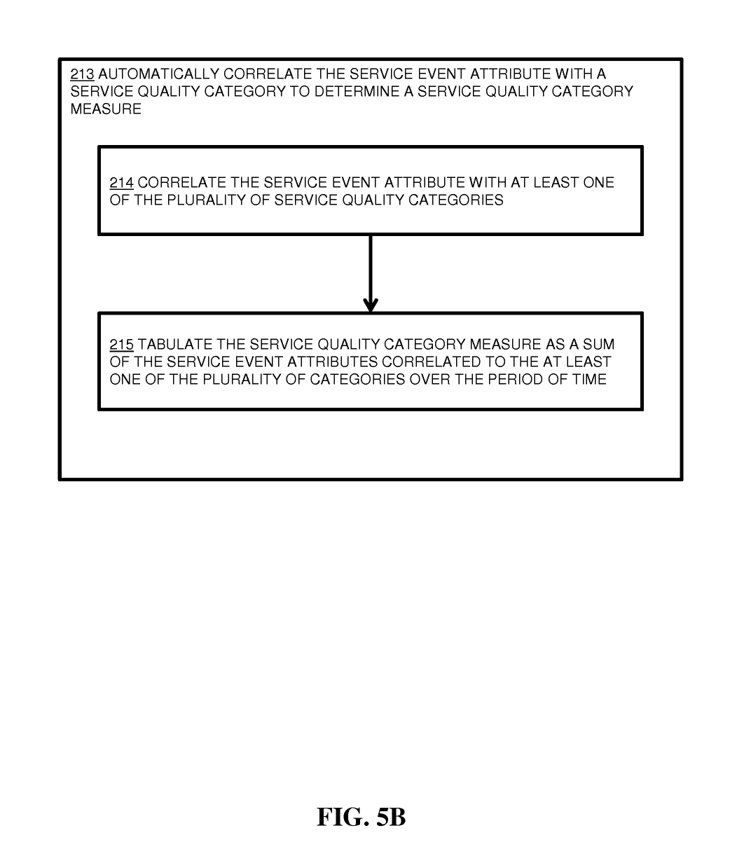

FIG. 5A is an embodiment of the steps performed by the service quality category measure providing process when it automatically correlates the service event attribute with a service quality category to determine a service quality category measure.

In step 209, the service quality category measure providing process automatically correlates the service event attribute with a service quality category to determine a service quality category measure. In step 210, the service quality category measure providing process receives a new service event with at least one new service event attribute within the period of time. For example, the service quality category measure providing process continually receives service events as service recipients enter new service requests. For each service request entered into the system, the service quality category measure providing process receives a respective new service event with at least one new service event attribute. In step 211, the service quality category measure providing process determines an updated service quality category measure based on the new service event attribute, and the service event attribute. In step 212, the service quality category measure providing process determines a trending measure associated with the updated service quality category measure where the trending measure reflects a trend between the service quality category measure and the updated service quality category measure. In an example embodiment, the service quality category measure providing process determines an updated service quality category measure. Based on the previous service quality category measures, the service quality category measure providing process determines a trending measure. In an example embodiment, the service quality category measure providing process may render this trending measure on the graphic interface to notify the service provider of the trend as new service events are entered into the system. Providing trending measures in specific quality categories notifies service providers of areas where service quality efforts are resulting in quality measures that are improving, declining, or remaining the same.

A trending measure may be determined by any type of statistical model such as but not limited to moving average models.

FIG. 5B is an embodiment of the steps performed by the service quality category measure providing process when it automatically correlates the service event attribute with a service quality category to determine a service quality category measure.

In step 213, the service quality category measure providing process automatically correlates the service event attribute with a service quality category to determine a service quality category measure. In an example embodiment, the service quality category comprises a plurality of service quality categories. In step 214, the service quality category measure providing process correlates the service event attribute with at least one of the plurality of service quality categories. The plurality of service quality categories may include a comfort category, a communication category, and a care category. The plurality of service quality categories may also include a responsiveness category, a discharge information category, a cleanliness category, a quietness category, a communication sub-category (communication with doctors, communication with nurses and/or communication about medicines), and a pain management category. In step 215, the service quality category measure providing process tabulates the service quality category measure as a sum of the service event attributes correlated to the at least one of the plurality of categories over the period of time. In an example embodiment, as shown in FIG. 1 the service quality category measure providing process 55 tabulates the service quality category measure as running averages. The average requests over the period of time are plotted to indicate whether the service provided are improving, worsening or staying the same. In another example embodiment, the service quality category measure providing process 55 calculates the service quality category measure as a sum of service event attributes over the period of time, where each of the service event attributes are correlated to one of the plurality of categories.

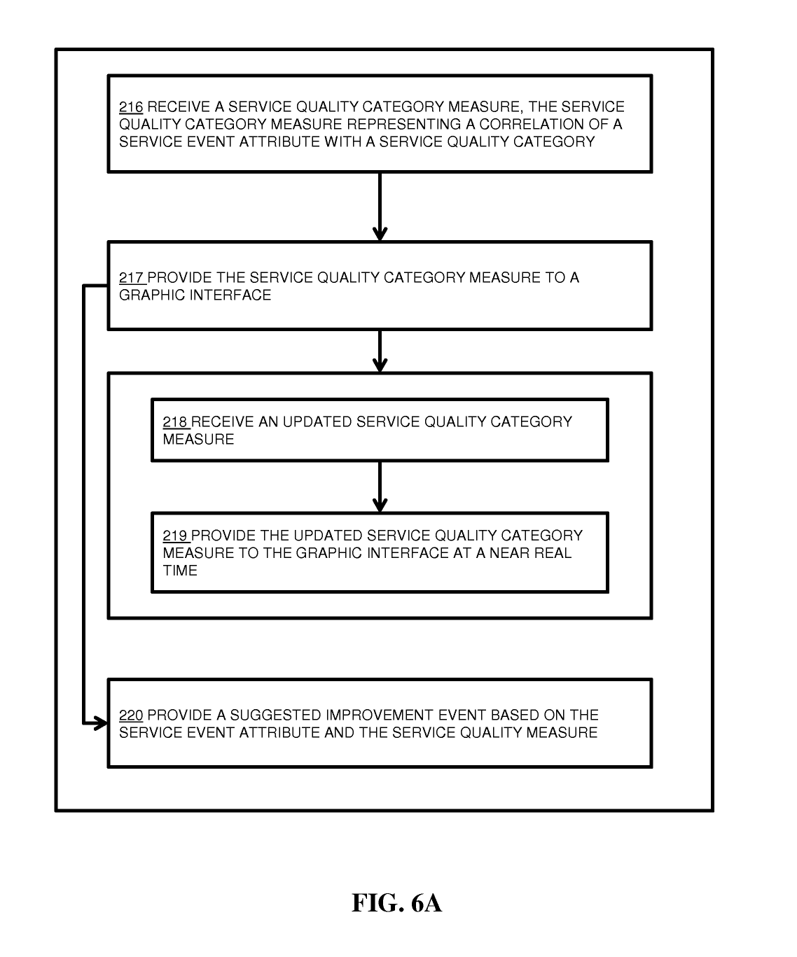

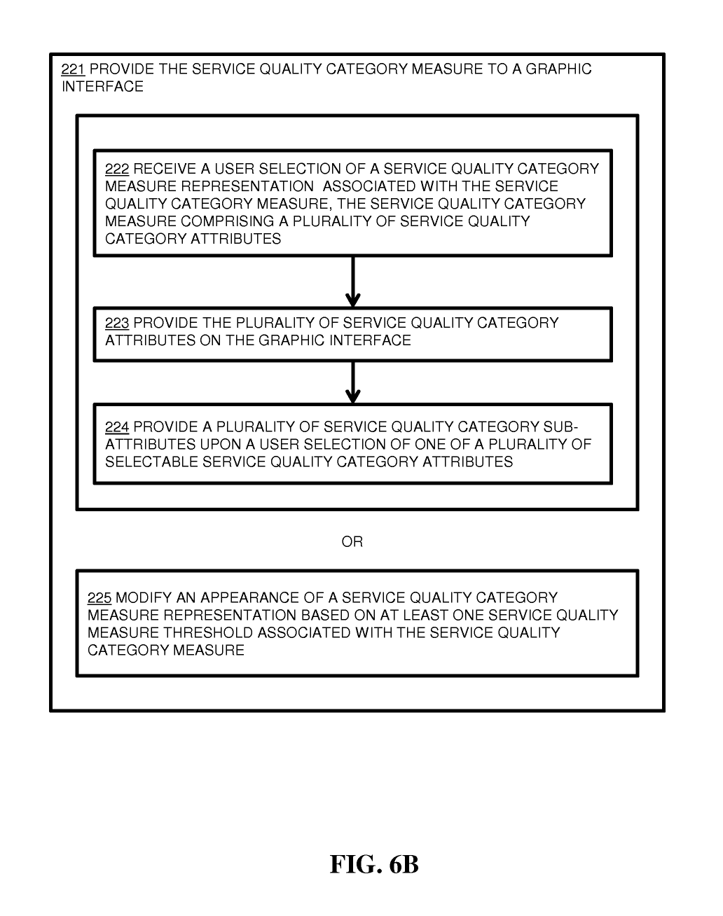

FIG. 6A is an embodiment of the steps performed by the service quality category measure providing process when it receives a service quality category measure.

In step 216, the service quality category measure providing process receives a service quality category measure. The service quality category measure represents a correlation of a service event attribute with a service quality category. In an example embodiment, a service recipient submits a service request to a service provider. In response, the service quality category measure providing process receives a service quality category measure that is determined based on the service request. In step 217, the service quality category measure providing process provides the service quality category measure to a graphic interface. The service quality category measure measures may be outputted to a reporting or display system such as desktop widget or a measure/icon on an executive dashboard. The service quality category measure may be outputted to any type of interface. In an example embodiment, as depicted in FIG. 1, a service quality category measure may be outputted to a graphic interface as a Patient Perspective Indicator.

In step 218, the service quality category measure providing process_receives an updated service quality category measure. In one example embodiment, after the service quality category measure providing process has received the service quality category measure, and provided the service quality category measure to a graphic interface, the service quality category measure providing process receives an updated service quality category measure. The updated service quality category measure is a service quality category measure that has been generated more recently than the service quality category measure received, in step 216, by the service quality category measure providing process. In step 219, the service quality category measure providing process provides the updated service quality category measure to the graphic interface at a near real time. In an example embodiment, when the service quality category measure providing process receives an updated service quality category measure, the service quality category measure providing process provides the updated service quality category measure to the graphic interface at a near real time.

In an example embodiment, the service event attribute that is correlated with a service quality category to determine the service quality category measure comprises a service request attribute of a service request initiated by a patient in a health care facility. The service quality category comprises at least one service quality category correlating to at least one HCAHPS measure.

In an example embodiment, the service event attribute comprises a service assessment attribute of a service assessment initiated by a health care provider. The service quality category comprises at least one service quality category correlating to at least one HCAHPS measure.

In an example embodiment, the service quality category measure is a predicted service quality category measure of at least one HCAHPS measure. The predicted service quality measure represents a predicted future HCAHPS measure. The quality of service offered by the service provider may be assessed by using service requests as a ‘service process defect’. By correlating a service request to a predicted HCAHPS measure, the service quality category measure providing process allows the service provider to improve or correct those service process defects with the intent of positively impacting the future HCAHPS measure.

Alternatively, in step 220, the service quality category measure providing process provides a suggested improvement event based on the service event attribute, and the service quality measure. A suggested improvement event is a recommendation for improving the services provided that the service quality category measure providing process presents to the service provider. In an example embodiment, the service quality category measure is provided in response to receipt of a service request. The service quality category measure providing process also provides a suggested improvement event based on the received service request. For example, the service quality category measure providing process may access a database of suggestions, and may retrieve a suggested improvement event based on the service event attributes. This provides the service provider with an opportunity to improve the services offered while the service recipient is still receiving those services, and also alerts the service provider to service areas that may need improvement.

FIG. 6B is an embodiment of the steps performed by the service quality category measure providing process when it provides the service quality category measure to a graphic interface.

In step 221, the service quality category measure providing process provides the service quality category measure to a graphic interface. As shown in the embodiment of FIG. 1, the service quality category measure providing process 55 provides the service quality category measure to a graphic interface, for example, in the form of a Patient Perspective Indicator.

In step 222, the service quality category measure providing process receives a user selection of a service quality category measure representation associated with the service quality category measure. The service quality category measure may comprise a plurality of service quality category attributes. In step 223, the service quality category measure providing process provides the plurality of service quality category attributes on the graphic interface. As shown in FIG. 1, the Patient Perspective Indicator may render a plurality of service quality category attributes, for example, displaying the service quality category measures according to service quality attributes, such as the categories of Comfort, Communication, and Care. In step 224, the service quality category measure providing process provides a plurality of service quality category sub-attributes upon a user selection of one of a plurality of selectable service quality category attributes. In an example embodiment, a user may select one of the plurality of selectable service quality category attributes to view additional information associated with that selected service quality category. In other words, the user may select the representation of the “Comfort” category on, for example, the Patient Perspective Indicator as shown in FIG. 1 to view additional information regarding the service requests that fall under the “Comfort” category. This additional information may include, but is not limited to, the number of service requests in a particular area, the service recipients entering those service requests, the service providers tasked with responding to those service requests, the service providers tasked with preventing the service process defects associated with those service requests, a deadline by which the service request must be addressed, etc.

Alternatively, in step 225, the service quality category measure providing process modifies an appearance of a service quality category measure representation based on at least one service quality measure threshold associated with the service quality category measure. A threshold may be determined through any type of statistical model. In an example embodiment, one threshold may be defined as one standard deviation above the mean, and another threshold may be defined as one standard deviation below the mean. The service quality category measure representation may be rendered on the graphic interface in one color when the threshold below the mean has been reached, a second color when the threshold above the mean has been reached, and a third color when the threshold is well below the mean.

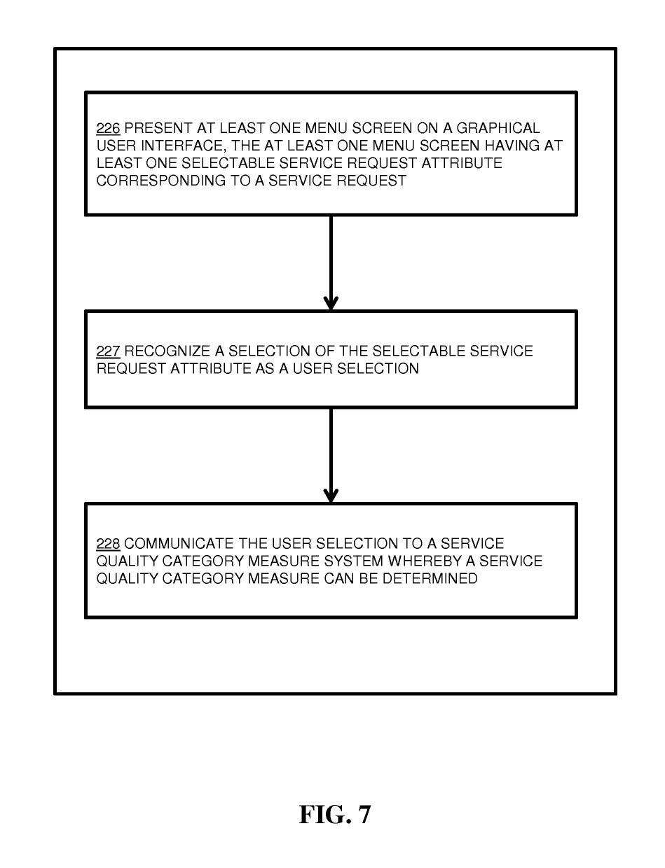

FIG. 7 is an embodiment of the steps performed by the service quality category measure providing process when it presents at least one menu screen on a graphic interface.

In step 226, the service quality category measure providing process presents at least one menu screen on a graphic interface where the menu screen has at least one selectable service request attribute corresponding to a service request. In an example embodiment, the service quality category measure providing process presents a graphic interface. The graphic interface may be any type of device with an interface, such as, but not limited to, a personal computer, a handheld communications device, a voice activated device, etc. In an example embodiment, the menu screen on the graphic interface is a Patient Bedside Panel PC as shown in FIG. 1. The menu screen on the Patient Bedside Panel PC may list the available selections, such as: “I need to ask my doctor some follow-up questions”, “I need more pain medication”, “I have questions about what I need to do after I go home”, “I need my room cleaned again”, “I need to speak with my nurse”, “My call button doesn't seem to be working”, “I have questions about my medication and dosage”, and “My room is very noisy”. The patient may select one of the available options on the Patient Bedside Panel PC to enter a service request. In an example embodiment, a service provider may enter information into the menu screen. The service provider may perform an action, for example, swiping an employee badge on a smart card reader, to indicate to the system that a service provider is entering information into the system via the menu screen. In step 227, the service quality category measure providing process recognizes a selection of the selectable service request attribute as a user selection. In an example embodiment, a user, such as a patient, selects one of the available options on the menu screen. The service quality category measure providing process asks the patient for confirmation of that selection prior to accepting the service request. In step 228, the service quality category measure providing process communicates the user selection to a service quality category measure system whereby a service quality category measure can be determined. In an example embodiment, the user selection correlates one to one to a service quality category. The service quality category measure providing process communicates that selection to the service quality category measure system where the service quality category measure can be determined based on the selection. In an example embodiment, the service quality category measure providing process receives a service request from, for example, a patient as a service event. The service quality category measure providing process also collects service event attributes associated with the service events, such as the patient name, patient location, attending doctor, attending nurse, etc. In an example embodiment, the service quality category measure providing process communicates a follow up confirmation to the patient to determine if the patient was satisfied with the response to the service request. The service quality category measure providing process adds the patient's follow up response as a service event attribute to the service event.

In an example embodiment, the selectable service request attribute further comprises a free text entry field. In an example embodiment, a user, such as a patient, enters the service request as free form text within a free text entry field. The service quality category measure providing process receives the service request, and correlates that free form text to a service quality category to determine the service quality category measure.

In an example embodiment, the service request attribute is related to a service quality category measure, and the service quality category measure is associated with an HCAHPS measure.

In an example embodiment, at least one selectable service request attribute is related to a service quality category, where the service quality category comprising at least one selected from the group consisting of a comfort category, a communication category, and a care category.

In an example embodiment, the service request attribute comprises a service request related to a service quality category, where the service quality category comprising at least one selected from the group consisting of a cleanliness category, a quietness category, a communication sub-category (i.e., communication with doctors, communication with nurse, and communication about medicines), a pain management category, a responsiveness category, and a discharge information category.

In another example embodiment the quality category measure providing process may be applied to any hospitality industry, including but not limited to hotels, airlines, restaurants and food service, etc., where service is provided by service providers, and received by service recipients. The quality category measure providing process may be applied to any industry where service providers are assessed using industry standards, and specifically where service providers are assessed by third parties. The service quality category measure may be an industry standard associated with the services provided by the hospitality service provider. The service quality category measure may also be based on a government standard.

One Example Embodiment of the Service Quality Measure System:

The service quality measure system generally provides the functionality for the methods discussed earlier to be carried out. And again, for illustration purposes only, one embodiment of the service quality measure system will be described using a service environment of a hospital being a service provider to their patients. It is understood that the systems may be applied to many other service environments.

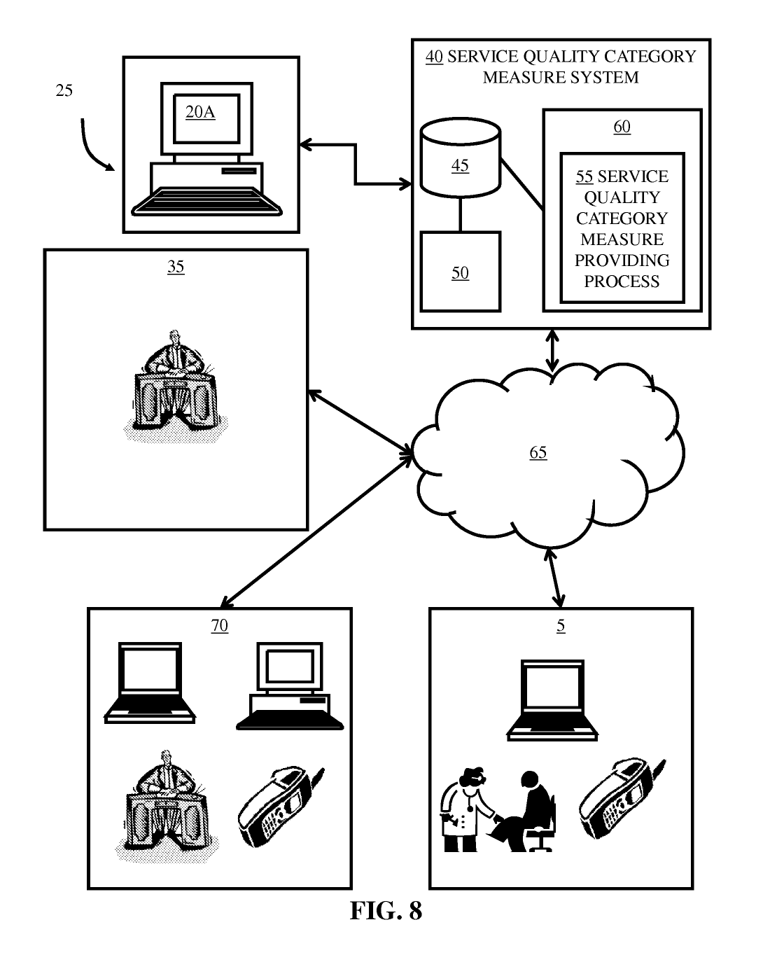

In some embodiments, the service quality measure system generally comprises a service recipient interface (such as a client interface 5), a communication network, a service provider interface (such as a graphic interface 20A), and a service provider system. FIG. 8 shows one embodiment of the service quality measure system 25 where the system generally includes a client interface 5, a communications network 65, a service quality category measure system 40 operated by a service provider, and a third party provider 35. The client interface 5 can generally be provided by any type of device that provides an interface for the recipient of the services of the service provider. The client interface 5 also provides communication between the user and the service system. In a preferred embodiment, the client device is a mobile computing device similar to a laptop computer, iPad, smartphone, PDA or digital phone in communication with a data network that is in communication with the service system and the service provider. In one implementation, the client interface 5 can include a keyboard, touchscreen and/or pointing device. In another implementation, the client interface 5 includes a monitor or other display unit for displaying output and graphical user interfaces.

The client interface 5 also includes a means to access the services of the service provider. This means to access can be an application on the client device such as a common web browser or software widget to access a service provider web site, or the means can comprise a custom designed application, such as a proprietary service request software application that resides on the client device and provides some service functionality without having to access the communications network.

The communication network 65 can be any type of communications network that allows the client device to communicate with the services of the service provider. In a preferred embodiment, the communications network is a data network capable of providing communications over a data network such as the Internet.

In some embodiments, third parties 35 are in communication with the service. Third parties 35 include those parties that provide quality control information to the service provider. In a preferred embodiment, third parties 35 include providers of quality control metrics such as HCAHPS survey providers. The service provider may also enter information into the service and get information from the service using their own client interface which may be any of the device and interface types described for client interface 5.

In some embodiments, service providers 70 are in communication with the service. Service providers include hospital personnel that may provide the service to the service recipient when the service recipient enters a service request using the service. In an example embodiment, a service provider 70 may enter information into the service using the client interface 5. The service provider 70 may perform an action, for example, swiping an employee badge on a smart card reader, to indicate to the system that a service provider 70 is entering information into the system via the client interface 5. The service provider may also enter information into the service and get information from the service using their own client interface which may be any of the device and interface types described for client interface 5.

Referring to FIG. 8, the service provider utilizes the service quality category measure system 40 to carry out the methods discussed earlier. One embodiment of the service provider system generally comprises a processor 50 in communication with a data repository or memory 45 capable of storing and retrieving processor executable instructions in a computer program product 60. In this embodiment, the service quality category measure system 40 can be accessed by a graphic interface 20A as may be needed for configuration or systems management or for outputting system data. Through this system, the service provider is capable of registering, activating, maintaining and terminating service for any client device. The service quality measure system computer program product 60 is detailed below, but in one embodiment, the computer program product includes a service quality measure software application, such as the service quality category measure providing process 55.

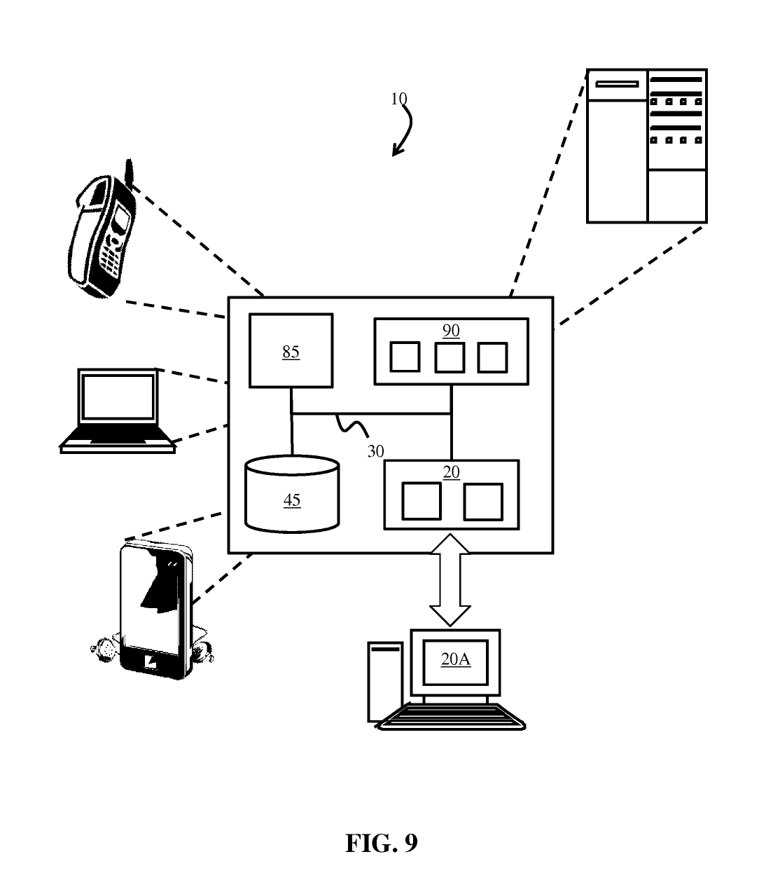

The various method embodiments of the service quality measure system will be generally implemented by a computer executing a sequence of program instructions for carrying out the steps of the methods, assuming all required data for processing is accessible to the computer, which sequence of program instructions may be embodied in a computer program product comprising media storing transitory and non-transitory embodiments of the program instructions. One example of a computer-based service quality measure system is depicted in FIG. 9 herein by which the method of embodiments disclosed herein may be carried out. One embodiment of the system includes a processing unit, which houses a processor, memory and other systems components that implement a general purpose processing system or computer that may execute a computer program product comprising media, for example a compact storage medium such as a compact disc, which may be read by processing unit through disc drive, or any means known to the skilled artisan for providing the computer program product to the general purpose processing system for execution thereby.

The computer program product may also be stored on hard disk drives within processing unit or may be located on a remote system such as a server, coupled to processing unit, via a network interface, such as an Ethernet interface. The monitor, mouse and keyboard can be coupled to processing unit through an input receiver or an output transmitter, to provide user interaction. The scanner and printer can be provided for document input and output. The printer can be coupled to processing unit via a network connection and may be coupled directly to the processing unit. The scanner can be coupled to processing unit directly but it should be understood that peripherals may be network coupled or direct coupled without affecting the ability of workstation computer to perform the method of embodiments disclosed herein.

As will be readily apparent to those skilled in the art, embodiments disclosed herein may be realized in hardware, software, or a combination of hardware and software. Any kind of computer/server system(s), or other apparatus adapted for carrying out the methods described herein, is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of embodiments disclosed herein, could be utilized.

Embodiments disclosed herein may also be embodied in a computer program product, which comprises all the respective features enabling the implementation of the methods described herein, and which, when loaded in a computer system, is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or reproduction in a different material form.

FIG. 9 is a schematic diagram of one embodiment of a general computer system 10. The system 10 can be used for the operations described in association with any of the computer-implemented methods described herein. The system 10 includes a processor 85, a memory 90, a storage device 45, and an input/output device 20. Each of the components 85, 90, 45, and 20 are interconnected using a system bus 30. The processor 85 is capable of processing instructions for execution within the system 10. In one implementation, the processor 85 is a single-threaded processor. In another implementation, the processor 85 is a multi-threaded processor. The processor 85 is capable of processing instructions stored as a computer program product in the memory 90 or on the storage device 45 to display information for a user interface on the input/output device 20.

The memory 90 stores information within the system 10. In some implementations, the memory 90 is a computer-readable storage medium. In one implementation, the memory 90 is a volatile memory unit. In another implementation, the memory 90 is a non-volatile memory unit.

The storage device 45 is capable of providing mass storage for the system 10. In some implementation, the storage device 45 is a computer-readable storage medium. In various different implementations, the storage device 45 may be a floppy disk device, a hard disk device, an optical disk device, or a tape device. The program product may also be stored on hard disk drives within the computer or it may be located on a remote system such as a server, coupled to processing unit, via a network interface, such as an Ethernet interface.

The input/output device 20 provides input/output operations for the system 10 and may be in communication with a user interface 20A as shown. In one implementation, the input/output device 20 can include a keyboard, touchscreen and/or pointing device. In another implementation, the input/output device 20 includes a monitor or other display unit for displaying output and graphical user interfaces.

The features described can be implemented in digital electronic circuitry, or in computer hardware, firmware, software, or in combinations of them such as but not limited to digital phone, cellular phones, laptop computers, desktop computers, digital assistants, servers or server/client systems. An apparatus can be implemented in a computer program product tangibly embodied in a machine-readable storage device, for execution by a programmable processor; and method steps can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a computer program of instructions include, by way of example, both general and special purpose microprocessors, and a sole processor or one of multiple processors of any kind of computer. Generally, a processor will receive instructions and data from a read-only memory or a random access memory or both. The elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube), LCD (liquid crystal display) or Plasma monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

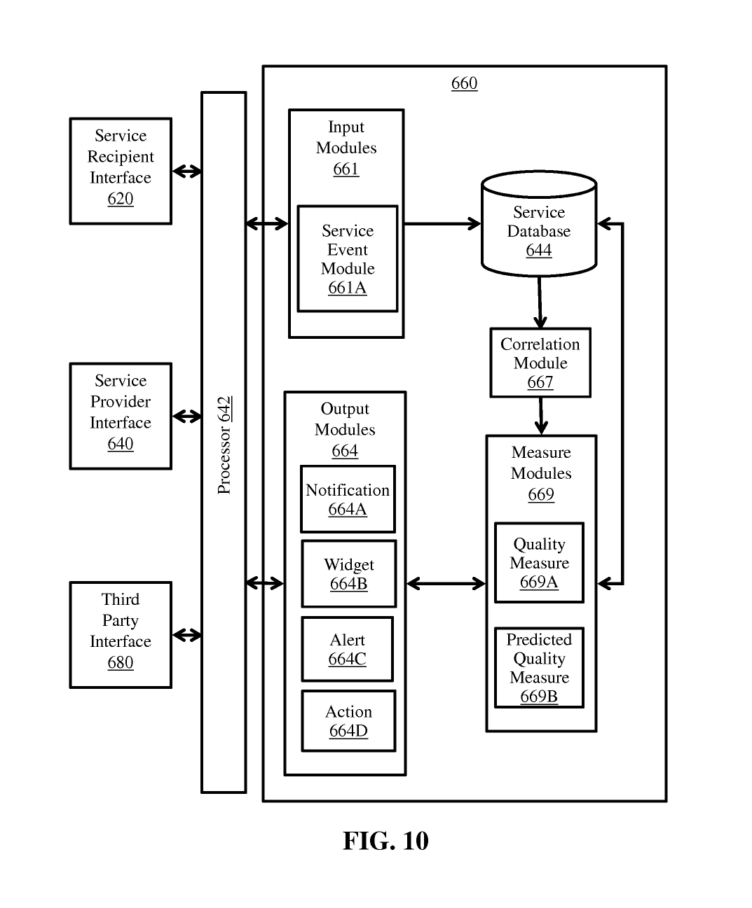

A functional diagram of one embodiment of the computer program product capable of executing the described methods is shown in the functional diagram in FIG. 10.

As shown, access to the computer program product is provided by a service recipient interface 620, a service provider interface 640 interacting with processor 642 communicating with the computer program product 660. The service recipient interface 620 may operate on a client interface. The service provider interface 640 may operate on a provider interface, such as a graphic interface. The computer program product 660 may operate on a service quality measure system. Utilizing the example embodiment, the computer program product 660 would typically receive a service event attribute from the service recipient through an input module 661 of which one is a service event module 661A. This service event is communicated to the service database 644 which shares the service event data with a correlation module 667. The correlation module 667 correlates the data from the service event into one of the measures tracked by the system. The correlation module 667 may include a comparison module that compares measures, tracked by the system, during correlation. The correlation module 667 may include a predicting model that is used when correlating the data from the service event into one of the measures tracked by the system. The correlation module 667 may include a tabulating module that tabulates one of the measures as a sum of service event attributes correlated to a quality category over a period of time. This correlated data is then used by the measure module 669 to create measures with a quality measure module 669A, or a predicted quality measure module 669B. The measure module 669 may also include a trending module that determines a trending measure reflecting a trend between the created measures. The resulting measures may be shared with the service database 644 and may be used by the output modules 664 to provide action and/or information from the service. Examples of suitable output modules 664 include, but are not limited to a notification module 664A to provide notification to the service provider, a widget module 664B to provide output to a widget in the service provider interface, an alert module 664C to notify the service provider of special requests or special measure results, and an action module 664D which may be able to automatically perform an action to address the request. The output modules 664 may include a threshold module that determines when the measures have exceeded thresholds. The threshold module may communicate those exceed thresholds to the widget module 664B.

In some embodiments, the third party has access to the system through a third party interface 680. This may allow them to provide the survey results directly to the service provider system for use by the computer program product.

The service provider interface 640 may include a desktop widget which allows the user to click on any of the area in the desktop widget enabling a “drill-down” with greater details relating to the questions and the factors that make up each area. For example, the desktop widget may have different icons or areas of the icon that correlate to different measures or different categories of measures and clinking on that area pulls down a set of menu choices for more detailed data behind that measure.

In some embodiments, the measures represent a real time Service Recipient Perspective Indicator that can be used within a quality control methodology to help improve service quality scores.

Although not shown, the computer program product may include other modules such as but not limited to: modules to compare the quality measures and the predicted quality measures to third party provided measures; modules to refine the algorithms in the correlation module based on the comparison of service measures to third party measures; modules to manipulate service data to create trends or other statistics; and modules to receive third party survey results.

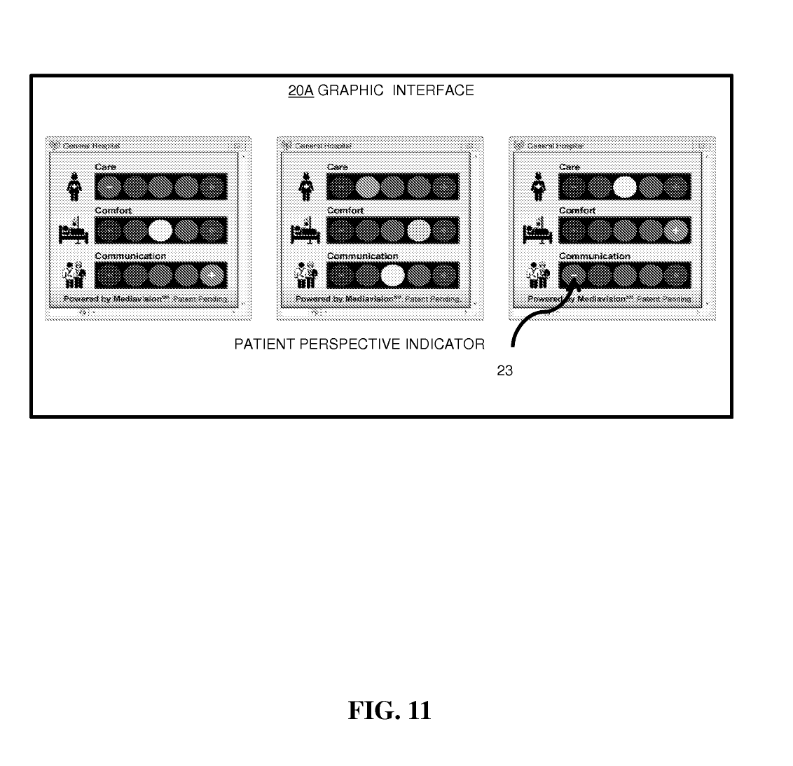

FIG. 11 illustrates an example screen shot of a Patient Perspective Indicator rendered on a graphic interface 20A. In this example, the Patient Perspective Indicator displays service quality category measure grouped in the service quality categories of Care, Comfort and Communication. In an example embodiment, the representations of the service quality category measure are color coded to indicate various quality measure thresholds. The representations change color as each threshold is reached, providing the user with an at-a-glance near real time assessment of the service provided to service recipients. In an example embodiment, the representations also render trending information. For example, a plus sign rendered on the representation may indicate that service quality category measure is trending in a positive direction. A minus sign rendered on the representation may indicate that the service quality category measure is trending in a negative direction. Neither a plus nor a minus sign rendered on the representation may indicate that the service quality category measure is holding steady. A user, such as a service provider, may select an area 23 of the desktop widget to “drill-down” with greater details relating to the questions and the factors that make up each area.

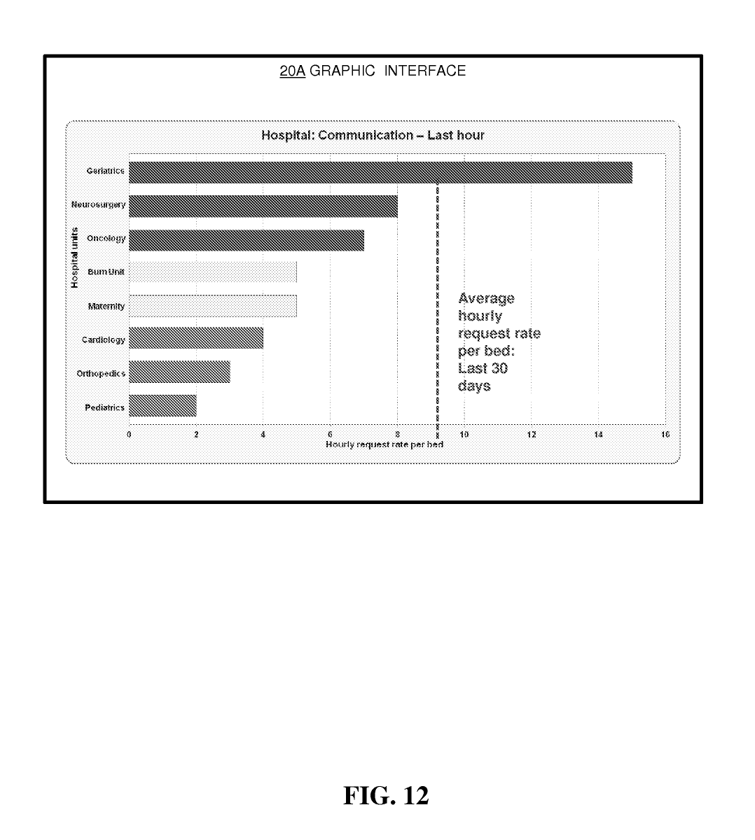

FIG. 12 illustrates an example screen shot of additional information provided by the Patient Perspective Indicator when a user selects an area of the desktop widget to “drill-down” to view greater details. The Patient Perspective Indicator is rendered on a graphic interface 20A. In an example embodiment, selection of an area 23 of the desktop widget depicted in FIG. 11 results in a drill-down view of details associated with the Communication category as shown in FIG. 12. In an example embodiment, the service quality category measure providing process provides an average hourly request rate per hospital bed, grouped according to hospital departments, aggregated over the past 30 days.

EXAMPLE EMBODIMENT WITH HCAHPS MEASURES:

In one example embodiment, the service event comprises a plurality of service events in a health care facility and the service quality category comprises a plurality of service quality categories correlating to HCAHPS measures. Using service quality categories correlating to HCAHPS measures is intended to help predict an actual HCAHPS result that may be received from an HCAHPS survey. In this embodiment, the third party service quality category measure may comprise the HCAHPS result that is reported back to the health care facility from a survey completed by a former patient in that health care facility. For example, a patient who was recently hospitalized may fill out an HCAHPS survey related to their recent hospital stay. Those HCAHPS results are reported back to the hospital. In an example embodiment, the HCAHPS results provide details on what percentage of patients evaluated a particular area of the hospital (for example, a service quality category) a “9” or “10” on a 0 to 10 rating scale (with 10 being the highest) and these results can be used as metrics to be correlated to the service quality category measures. The original service quality category measures may be used to predict those HCAHPS results before they are received and the HCAHPS results may also be used to update correlations in the service quality category measure providing process. For example, an increase in running averages of service requests (problems) may translate into a lower (i.e., inferior) HCAHPS result. Therefore, the quality category measure system may correlate the number of service requests to a service quality category measure, and then compare the service quality category measure with a predicted service quality category measure to update a predicting model used to generate the predicted service quality category measure.

In this example embodiment, consistent with CAHPS Hospital Survey (HCAHPS) Quality Assurance Guidelines, Version 6.0, the HCAHPS survey used to create the HCAHPS result may include the 27 items, or questions listed below, according to their respective survey grouping A-G which may be used as HCAHPS measures and service quality categories:

A. Your Care From Nurses

1. During this hospital stay, how often did nurses treat you with courtesy and respect?

2. During this hospital stay, how often did nurses listen carefully to you?

3. During this hospital stay, how often did nurses explain things in a way you could understand?

4. During this hospital stay, after you pressed the call button, how often did you get help as soon as you wanted it?

B. Your Care From Doctors 5. During this hospital stay, how often did doctors treat you with courtesy and respect?6. During this hospital stay, how often did doctors listen carefully to you?7. During this hospital stay, how often did doctors explain things in a way you could understand?

C. The Hospital Environment 8. During this hospital stay, how often were your room and bathroom kept clean?9. During this hospital stay, how often was the area around your room quiet at night?

D. Your Experiences in This Hospital 10. During this hospital stay, did you need help from nurses or other hospital staff in getting to the bathroom or in using a bedpan?11. How often did you get help in getting to the bathroom or in using a bedpan as soon as you wanted?12. During this hospital stay, did you need medicine for pain?13. During this hospital stay, how often was your pain well controlled?14. During this hospital stay, how often did the hospital staff do everything they could to help you with your pain?15. During this hospital stay, were you given any medicine that you had not taken before?16. Before giving you any new medicine, how often did hospital staff tell you what the medicine was for?17. Before giving you any new medicine, how often did hospital staff describe possible side effects in a way you could understand?

E. When you Left Hospital 18. After you left the hospital, did you go directly to your own home, to someone else's home, or to another health facility?

19. During this hospital stay, did doctors, nurses or other hospital staff talk with you about whether you would have the help you needed when you left the hospital?

20. During this hospital stay, did you get information in writing about what symptoms or health problems to look out for after you left the hospital?

F. Overall Rating of Hospital

Please answer the following questions about your stay at the hospital named on the cover letter. Do not include any other hospital stays in your answers.

21. Using any number from 0 to 10, where 0 is the worst hospital possible and 10 is the best hospital possible, what number would you use to rate this hospital during your stay?

22. Would you recommend this hospital to your friends and family?

G. About You

23. In general, how would you rate your overall health?

24. What is the highest grade or level of school that you have completed?

25. Are you of Spanish, Hispanic or Latino origin or descent?

26. What is your race? Please choose one or more.

27. What language do you mainly speak at home?

In another example embodiment, the 27 items or questions listed above may be grouped into service quality categories irrespective of the survey grouping A-G. For example, Questions 1, 2 and 3 may be grouped as a service quality category, such as a communication sub-category, while questions 13 and 14 may be grouped into a different service quality category, such as a pain management category, etc.

In another example embodiment, consistent with CAHPS Hospital Survey (HCAHPS) Quality Assurance Guidelines, Version 7.0, the HCAHPS survey may include an extended survey including questions related to:
Hospital considered patient's preferences regarding post-discharge health care needs
Patient understood own responsibilities in managing health post-discharge
Patient understood the purpose of post-discharge medications
Patient admitted through the emergency room
Patient's self-rating of mental or emotional health

Although embodiments disclosed herein have been described in the above forms with a certain degree of particularity, it is understood that the foregoing is considered as illustrative only of the principles of embodiments disclosed herein. Further, since numerous modifications and changes will readily occur to those skilled in the art, it is not desired to limit embodiments disclosed herein to the exact construction and operation shown and described, and accordingly, all suitable modifications and equivalents may be resorted to, falling within the scope of embodiments disclosed herein which is defined in the claims and their equivalents.

The reader's attention is directed to all papers and documents which are filed concurrently with his specification and which are open to public inspection with this specification, and the contents of all such papers and documents are incorporated herein by reference. All features disclosed in this specification (including any accompanying claims, abstract, and drawings) may be replaced by alternative features serving the same, equivalent or similar purpose, unless expressly stated otherwise. Unless expressly stated otherwise, each feature disclosed is one example only of a generic series of equivalent or similar features.

We claim:

1. A processor based method of determining a service quality category measure, the method comprising:
receiving a service event attribute reflecting a service event over a period of time; and
automatically correlating the service event attribute with a service quality category to determine a service quality category measure.

2. The method of claim 1 wherein:
the service event attribute comprises a service request attribute;
the service quality category comprises a plurality of service quality categories; and
the plurality of service quality categories comprises at least one selected from the group consisting of:
i) a comfort category;
ii) a communication category; and
iii) a care category.

3. The method of claim 1 wherein:
the service event attribute comprises a service request attribute;
the service quality category comprises a plurality of service quality categories; and
the plurality of service quality categories comprises at least one selected from the group consisting of:
i) a cleanliness category;
ii) a quietness category;
iii) a communication sub-category; and
iv) a pain management category.

4. The method of claim 3 wherein:
the plurality of service quality categories further comprises at least one selected from the group consisting of:
i) a responsiveness category; and
ii) a discharge information category.

5. The method of claim 1 wherein:
the service event attribute comprises a service request attribute of a service request initiated by a patient in a health care facility; and
the service quality category comprises at least one service quality category correlating to an HCAHPS measure.

6. The method of claim 1 wherein:
the service event attribute comprises a service assessment attribute of a service assessment of a health care provider; and
the service quality category comprises at least one service quality category correlating to an HCAHPS measure.

7. The method of claim 1 wherein the method further comprises correlating the service quality category measure to a predicted service quality category measure.

8. The method of claim 7 further comprising:
receiving a third party service quality category measure;
comparing the third party service quality category measure to the service quality category measure to create an actual category measure difference;
comparing the third party service quality category measure to the predicted service quality category measure to create an actual predicted measure category difference;
the step of correlating the service quality measure utilizing a predicting model; and
updating the predicting model based on the actual category measure difference and the predicted measure category difference.

9. The method of claim 8 wherein:
the service event comprises a plurality of service events in a health care facility;
the service quality category comprises a plurality of service quality categories correlating to HCAHPS measures; and
the third party service quality category measure comprises a HCAHPS result.

10. The method of claim 1 further comprising:
receiving a new service event with at least one new service event attribute within the period of time;
determining an updated service quality category measure based on the new service event attribute and the service event attribute; and
determining a trending measure associated with the updated service quality category measure reflecting a trend between the service quality category measure and the updated service quality category measure.

11. The method of claim 1 wherein:
the service quality category comprises a plurality of service quality categories; and
the step of correlating the service event attribute with a service quality category to determine a service quality category measure comprises:
correlating the service event attribute with at least one of the plurality of service quality categories; and
tabulating the service quality category measure as a sum of the service event attributes correlated to the at least one of the plurality of categories over the period of time.

12. The method of claim 1 wherein a service process defect is associated with the service event attribute and a suggested improvement event is communicated to a service provider based on the service process defect.

13. A processor-based method of providing a service quality category measure, the method comprising:
receiving a service quality category measure;
the service quality category measure representing a correlation of a service event attribute with a service quality category; and
providing the service quality category measure to a graphic interface.

14. The method of claim 13 further comprising:
receiving an updated service quality category measure; and
providing the updated service quality category measure to the graphic interface at a near real time.

15. The method of claim 13 wherein:
the service event attribute comprises a service request attribute of a service request initiated by a patient in a health care facility; and
the service quality category comprises at least one service quality category correlating to at least one HCAHPS measure.

16. The method of claim 13 wherein the service quality category measure is a predicted service quality category measure of at least one HCAHPS measure.

17. The method of claim 13 wherein providing the service quality category measure to a graphic interface further comprises:
receiving a user selection of a service quality category measure representation associated with the service quality category measure;
the service quality category measure comprising a plurality of service quality category attributes; and
providing the plurality of service quality category attributes on the graphic interface.

18. The method of claim 17 wherein providing a plurality of attributes on the graphic interface further comprises providing a plurality of service quality category sub-attributes upon a user selection of one of the plurality of service quality category attributes.

19. A processor based method, the method comprising:
presenting at least one menu screen on a graphic interface, the at least one menu screen having at least one selectable service request attribute corresponding to a service request;
recognizing a selection of the selectable service request attribute as a user selection; and
communicating the user selection to a service quality category measure system whereby a service quality category measure can be determined.

20. The method of claim 19 wherein:
the service request attribute is related to a service quality category measure; and
the service quality category measure is associated with an HCAHPS measure.

21. The method of claim 19 wherein the at least one selectable service request attribute is related to a service quality category, the service quality category comprising at least one selected from the group consisting of:
i) a comfort category;
ii) a communication category; and
iii) a care category.
